(19) United States
(12) Patent Application Publication
(10) Pub. No.: US 2015/0032380 A1
(43) Pub. Date: Jan. 29, 2015

(54) PLURAL DEPTH SEISMIC DE-GHOSTING METHOD AND SYSTEM

(71) Applicant: CGG SERVICES SA, Massy Cedex (FR)

(72) Inventor: Julien COTTON, Paris (FR)

(21) Appl. No.: 14/338,696

(22) Filed: Jul. 23, 2014

Related U.S. Application Data
(63) Continuation-in-part of application No. 14/054,505, filed on Oct. 15, 2013.
(60) Provisional application No. 61/858,234, filed on Jul. 25, 2013.

(51) Int. Cl. G01V 1/36

(52) U.S. Cl. CPC G01V 1/36; G01V 1/364; G01V 2210/6122; G01V 2210/56
USPC 702/17

(57) ABSTRACT

A method for de-ghosting seismic data includes receiving seismic data corresponding to plural depth sources or plural depth receivers located at a first depth and a second depth below a geophysical surface, wherein the second depth is below the first depth, where the plural depth sources or plural depth receivers comprise a first seismic receiver located at the first depth and a second seismic receiver located at the second depth, or, a first seismic source located at the first depth and a second seismic source located at the second depth. The method also includes aligning primary reflections within the seismic data to provide improved seismic data. A corresponding system is also disclosed herein.

### CROSS-REFERENCE TO RELATED APPLICATIONS

This application is a Continuation-in-Part of co-pending application Ser. No. 14/054,505 filed on Oct. 15, 2013, and entitled “PLURAL DEPTH SEISMIC SOURCE SPREAD METHOD AND SYSTEM” and for which priority is claimed under 35 U.S.C. §120. This application also claims priority to Provisional Application No. 61/858,234, filed on Jul. 25, 2013, and entitled “DE-GHOSTING PROCESSING METHOD FOR PLURAL DEPTH BURIED SOURCES AND/OR PLURAL DEPTH BURIED SENSORS IN 4D SEISMIC ACQUISITION” and for which priority is claimed under 35 U.S.C. §119. The entire content of each of these applications is incorporated herein by reference.

### BACKGROUND

1. Technical Field

Embodiments of the subject matter disclosed herein relate generally to the field of geophysical data acquisition and processing. In particular, the embodiments disclosed herein relate to methods and systems for acquiring and processing seismic data from plural depth buried sources and receivers.

2. Discussion of the Background

Geophysical data is useful for a variety of applications, reservoir monitoring, subsoil imaging, environmental monitoring, mining, and seismology. As the economic benefits of such data have been proven, and additional applications for geophysical data have been discovered and developed, the demand for localized, high-resolution, and cost-effective geophysical data has greatly increased. This trend is expected to continue.

For example, seismic data acquisition and processing may be used to generate a profile (image) of the geophysical structure under the ground (either on land or seabed). While this profile does not provide an exact location for oil and gas reservoirs, it suggests, to those trained in the field, the presence or absence of such reservoirs. Thus, providing a high-resolution image of the subsurface of the earth is important, for example, to those who need to determine where oil and gas reservoirs are located.

Traditionally, a land seismic survey system 10 capable of providing a high-resolution image of the subsurface of the earth is generally configured as illustrated in FIG. 1 (although many other configurations are used). System 10 includes plural receivers 12 and acquisition units 12a positioned over an area 13 of a subsurface to be explored and in contact with the surface 14 of the ground. A number of seismic sources 16 are also placed on surface 14 in an area 17, in a vicinity of area 13 of receivers 12. The area 13 corresponding to the receivers 16 and the area 17 corresponding to the sources 16 may, or may not be, overlapping areas on the surface 14. A recording device 18 is connected to a plurality of receivers 12 and placed, for example, in a station-truck 20. Each source 16 may be composed of a variable number of vibrators or explosive devices, and may include a local controller 22. A central controller 24 may be present to coordinate the shooting times of the sources 16. A GPS system 26 may be used to time-correlate sources 16 and receivers 12 and/or acquisition units 12a.

With this configuration, the sources 16 are controlled to generate seismic waves, and the receivers 12 record the waves reflected by the subsurface. The receivers 12 and acquisition units 12a may be connected to each other and the recording devices with cables 30. Alternately, the receivers 12 and acquisition units 12a can be paired as autonomous nodes that do not need the cables 30. While the depicted seismic survey system 10 is a land seismic survey, an ocean bottom survey system may have similar components.

The purpose of seismic imaging is to generate high-resolution images of the subsurface from acoustic reflection measurements made by the receivers 12. Conventionally, as shown in FIG. 2a, the seismic sources 16 and receivers 12 are distributed on the ground surface at a distance from each other. The sources 16 are activated to produce seismic waves that travel through the subsoil. These seismic waves undergo deviations as they propagate. They are refracted, reflected, and diffracted at the geological interfaces of the subsoil. For example, waves 40 that travel through the subsoil and are reflected from a subsurface 50 may be detected by the seismic receivers 12. The reflected waves may be recorded as a function of time in the form of signals (called traces).

The seismic sources 16 may be placed at a variety of source locations and the receivers 12 may be placed at a variety of receiving locations on the surface 52. The source locations and the receiving locations may be selected to provide a sufficient number of traces to capture the features of the subsurface with high fidelity.

In many seismic survey applications, known as 4D seismic surveys, it is desirable to detect changes in the subsurface 50 over time. However, with the configuration shown in FIG. 2a, variations in the surface 52 and the weathering region 60 may be subject to significant changes that make it difficult to detect changes in the subsurface 50. For example, the moisture content of the weathering region 60 may change dramatically and alter the velocity of the waves 40. The surface 52 may also be subject to erosion or soil deposition that alters the position of the sources 16 and receivers 12 relative to the subsurface 50.

To mitigate the changing conditions of the surface 52 and the weathering region 60, the sources 16 and receivers 12 may be buried below the weathering region 60 and placed in a region of greater stability as is shown in FIG. 2b. However, as shown in FIG. 2c, ghost reflections 70 of the waves 40 from the weathering region 60 and the surface 52 contribute to the signal received by the receivers 12 resulting in additional 4D noise and reduced accuracy.

Due to the foregoing, there is a need for seismic data acquisition and processing systems and methods that are able to reduce noise from ghost reflections

### SUMMARY

As detailed herein, a method for de-ghosting seismic data includes receiving seismic data corresponding to plural depth sources or plural depth receivers located at a first depth and a second depth below a geophysical surface, wherein the second depth is below the first depth, where the plural depth sources or plural depth receivers comprise a first seismic receiver located at the first depth and a second seismic receiver located at the second depth, or, a first seismic source located at the first depth and a second seismic source located at the second depth. The method also includes aligning primary reflections within the seismic data to provide improved seismic data. A corresponding system is also disclosed herein.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram depicting a traditional land seismic survey system;

FIG. 2a is a schematic diagram depicting selected portions of a traditional 4D reservoir monitoring system with sources and receivers placed proximate to a geophysical surface;

FIG. 2b is a schematic diagram depicting selected portions of a traditional 4D reservoir monitoring system with single depth sources and receivers;

FIG. 2c is a schematic diagram depicting ghost reflections associated with traditional 4D reservoir monitoring systems;

FIG. 3 is a schematic diagram depicting selected portions of a 4D monitoring system with buried plural depth sources and receivers;

FIG. 4 is a schematic diagram depicting reduced ghost reflections associated with a plural depth source spread;

FIG. 5a is a schematic diagram depicting reduced ghost reflections associated with a plural depth receiver spread;

FIG. 5b is a timing diagram depicting shifted reflections associated with a shifting subsurface in a 4D seismic survey that leverages a plural depth source or a plural depth receiver spread;

FIG. 6 is a flowchart diagram depicting one embodiment of a plural depth seismic processing method;

FIG. 7 is a flowchart diagram depicting one embodiment of a 4D plural depth seismic processing method;

FIGS. 8a-8g are schematic diagrams depicting various placement configurations for plural depth source and/or receiver spreads;

FIG. 9 is a flowchart diagram depicting one embodiment of a plural depth processing method;

FIG. 10 is a timing and schematic diagram illustrating how a receiver ghost signal can be isolated from a primary signal and a source ghost signal via dual-depth sensors;

FIG. 11a is a plot of seismic data processed from single depth seismic sources and FIG. 11b is a plot of seismic data processed from plural depth seismic sources; and

FIG. 12 is a block diagram of a computing device for processing seismic data.

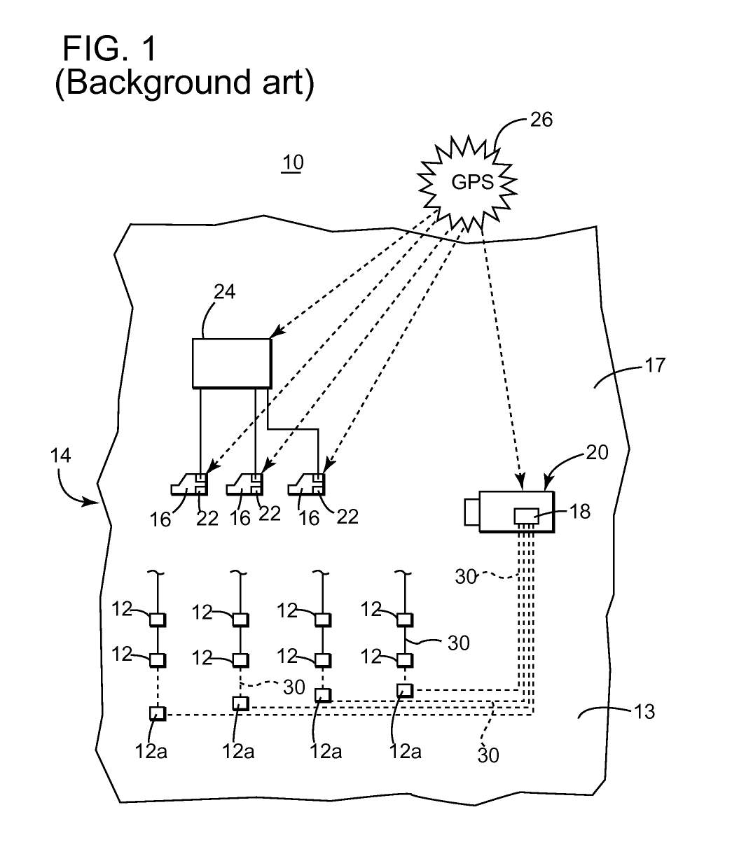

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

A system and method for acquiring and improving seismic data is presented herein. Applicants have observed that the data precision and stability obtained with disclosed system and method enables subsurface change detection with shorter elapsed times and smaller amplitude variations than attainable with conventional systems and methods. For example, amplitude variations associated with steam injection into a reservoir are detectable with the disclosed system and method.

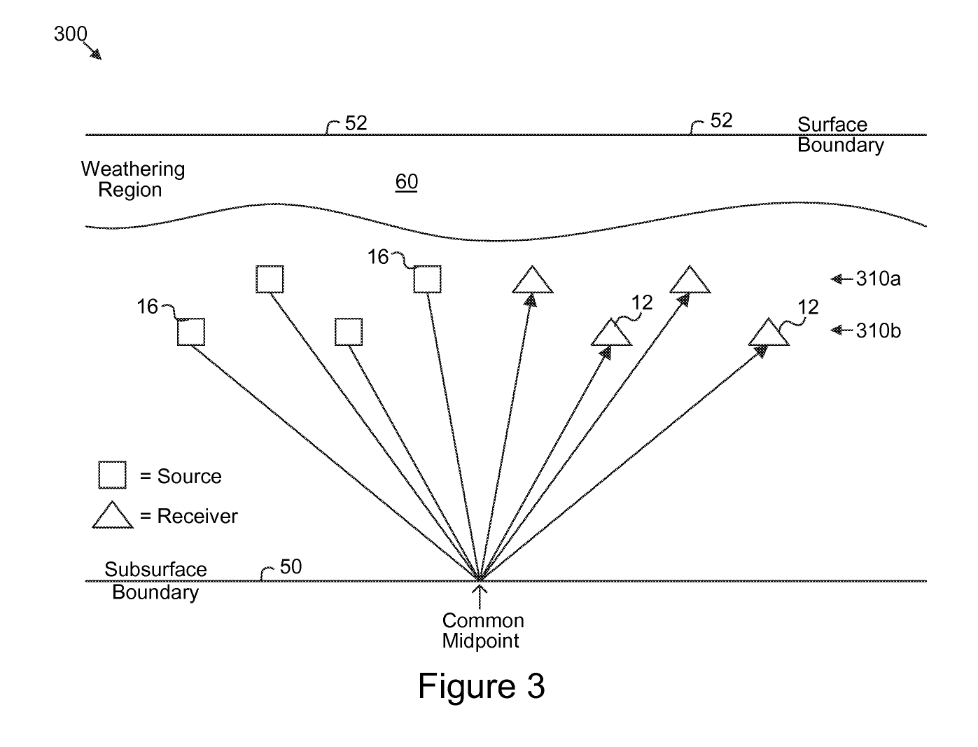

FIG. 3 is a schematic diagram depicting selected portions of a 4D monitoring system 300 with buried plural depth sources and/or receivers. The 4D monitoring system 300 includes one or more sources 16 and one or more receivers 12 that are placed at plural depths 310 below a geophysical surface such as the surface of the earth, a seabed, a river bed or the like. In the depicted arrangement, the plural depths 310 include a first depth 310a and a second depth 310b. The use of plural depths reduces ghost reflections and improves 4D (both continuous and time-lapse) seismic repeatability as will be shown in subsequent figures.

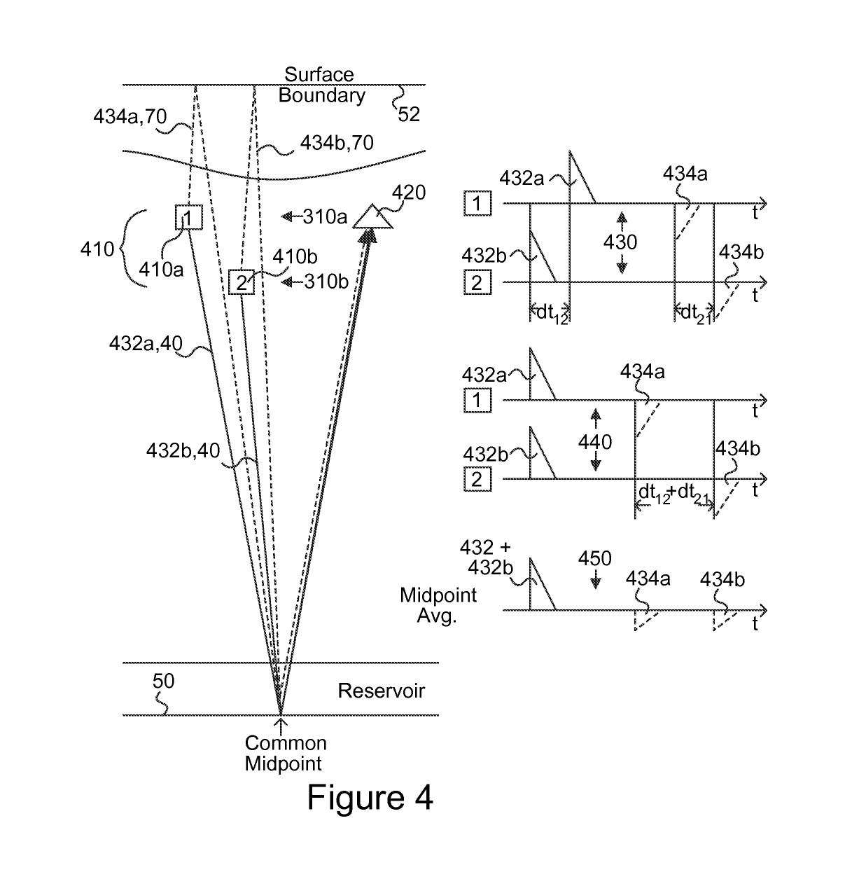

FIG. 4 is a schematic diagram depicting one example of reduced ghost reflections that may occur for a plural depth source spread 410. The depicted source spread 410 includes a source 410a at a first depth 310a and a source 410b at a second depth 310b. For the purpose of clarity, a simplified scenario, where the reflection angles are assumed to be substantially vertical (i.e., the cosine of the propagation angle relative to vertical is substantially equal to 1.0), demonstrates how the source spread 410 reduces ghost reflections and improves 4D seismic repeatability.

A seismic source wave such as an impulse may be generated by each source in the source spread 410 at a distinct time. In response thereto, a trace corresponding to each source may be recorded by a receiver 420. As shown on the right side of FIG. 4, the traces may be time-aligned relative to the firing of the sources 410a and 410b to provide synchronized traces 430. In one embodiment, time alignment is enabled by synchronized clocks on the sources 410 and the receiver 420.

Due to the difference in depths between the source 410a and the source 410b, a primary (i.e., subsurface) reflection 432b from the source 410b arrives at the receiver 420 earlier (e.g., by time difference dt₁₂) relative to the source event than a primary reflection 432a from the source 410a. The difference in depths between the source 410a and the source 410b also results in a ghost reflection 434b from the source 410b arriving at the receiver 420 earlier (e.g., by time difference dt₂₁) relative to the source event than a ghost reflection 434a from the source 410a. The time difference dt₁₂ may be substantially equal to dt₂₁ despite a difference in the direction of wave propagation between the source 410a and the source 410b for the primary reflections 432 and the ghost reflections 434.

During processing, one of the traces 430 may be phase-shifted or time-shifted to provide aligned traces 440 where the primary reflections 432a and 432b are aligned and the ghost reflections 434a and 434b are further misaligned. Subsequently, the traces may be summed or averaged to provide a common midpoint trace 450 with reduced ghost reflections 434a and 434b relative to the primary reflections 432a and 432b.

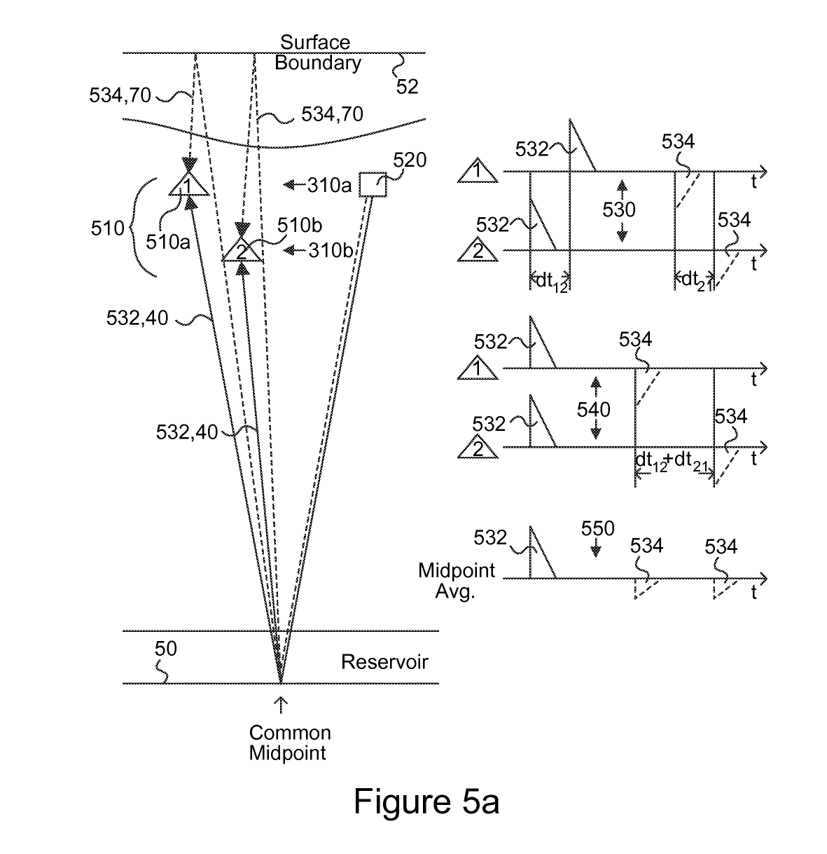

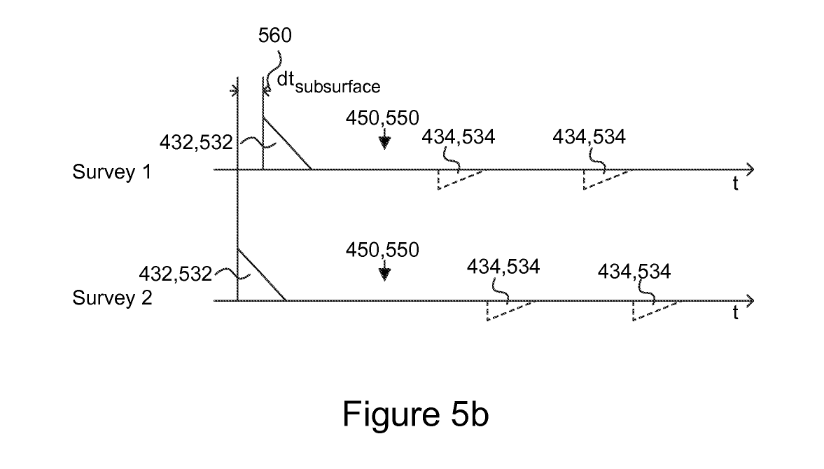

FIG. 5a is a schematic diagram depicting one example of reduced ghost reflections that may occur for a plural depth receiver spread 510. The depicted receiver spread 510 includes a source 510a at a first depth 310a and a source 510b at a second depth 310b. For the purpose of clarity, a simplified scenario, where the reflection angles are assumed to be substantially vertical (i.e., the cosine of the propagation angle relative to vertical is substantially equal to 1.0), demonstrates how the receiver spread 510 reduces ghost reflections and improves 4D seismic repeatability.

A seismic source wave such as an impulse may be generated by the source 520 at a distinct time. In response thereto, a trace corresponding to each source may be recorded by each receiver in the receiver spread 510. As shown on the right side of FIG. 5, the traces may be time-aligned relative to the firing of the source 520 to provide synchronized traces 530. In one embodiment, time alignment is enabled by synchronized clocks on the source 520 and each receiver of the receiver spread 510.

Due to the difference in depths between the receiver 510a and the receiver 510b, a primary (i.e., subsurface) reflection 532 from the source 520 arrives at the receiver 510b earlier (e.g., by time difference dt₂₁) relative to the source event than the primary reflection 532 arrives at the receiver 510a The difference in depths between the receiver 510a and the receiver 510b also results in a ghost reflection 534 from the source 520 arriving at the receiver 510a earlier (e.g., by time difference dt₁₂) relative to the source event than the ghost reflection 534 arrives at the receiver 510b. The time difference dt₁₂ may be substantially equal to dt₂₁ despite a difference in the direction of wave propagation between the receiver 510a and the receiver 510b for the primary reflection 532 and the ghost reflection 534.

During processing, one of the traces 530 may be phase-shifted or time-shifted to provide aligned traces 540 where the primary reflections 532 are aligned and the ghost reflections 534 are further misaligned. Subsequently, the traces 540 may be summed or averaged to provide a common midpoint trace 550 with reduced ghost reflections 534 relative to the summed or averaged primary reflection 532.

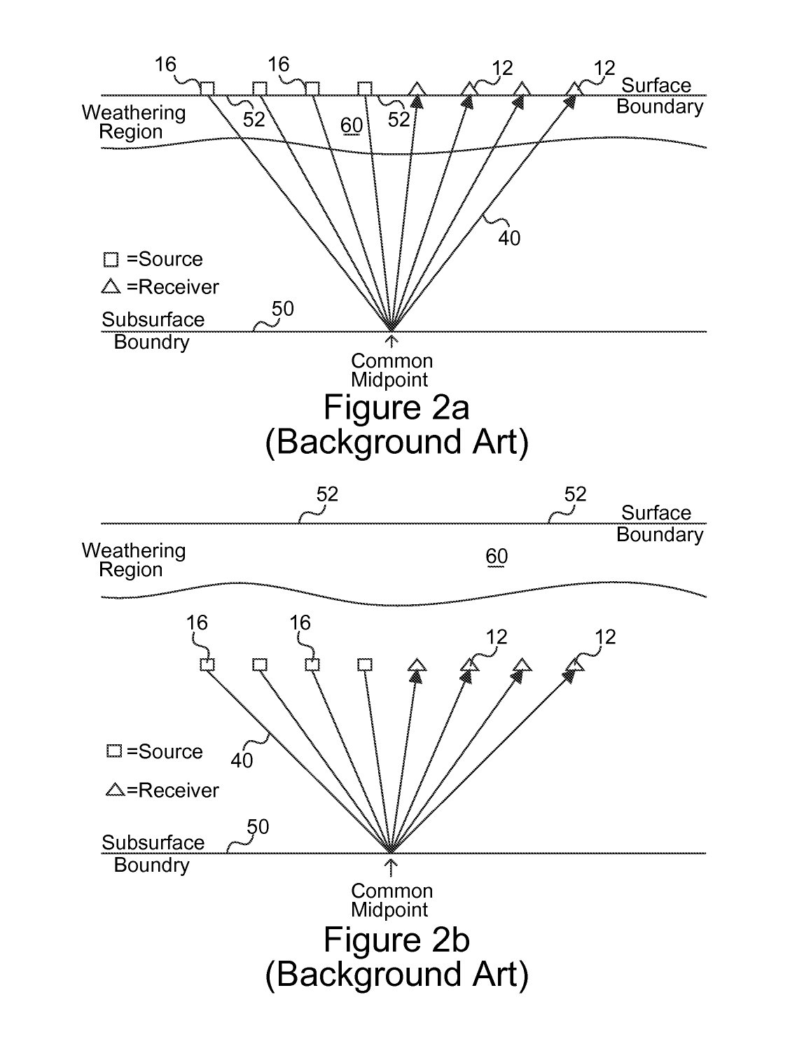

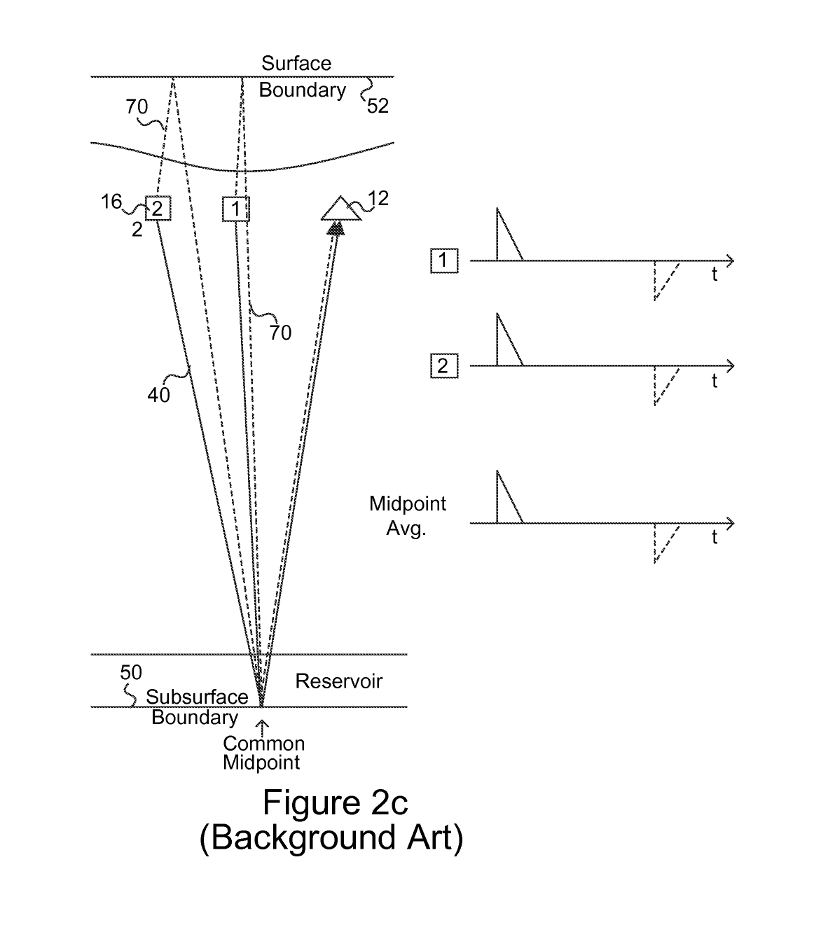

The simplicity of the above scenarios demonstrates the value of using a plural depth source spread and/or a plural depth receiver spread. As shown in FIGS. 4 and 5a, and in comparison to the prior art (see, for example, FIG. 2c) ghost reflections may be significantly reduced and result in improved seismic data. Furthermore (optional) explicit de-ghosting operations may be conducted on the improved seismic data (e.g., seismic data filtering or generating a model of the primary reflections using matrix inversion) in order to further reduce ghost reflections.

Mathematically, the seismic data corresponding to a plural depth source or receiver spread may be represented in the frequency domain as:

S₁(f)=P₁(f)+G₁(f) (1)

S₂(f)=P₂(f)+G₂(f) (2)

where f is a selected frequency, S₁ and S₂ represent signals corresponding to sources or receivers at two distinct depths (namely z₁ and z₂), P₁ and P₂ represent up-going (i.e., primary) waves that occur at those depths, and G₁ and G₂ represent down-going (i.e., ghost) waves. The relationship between up-going waves P and down-going waves G at the two depths may be represented as:

τ=e^{-i2π(dt)} (3)

dt=Δz/V (4)

where f is the frequency component of the signal, τ is a phase term corresponding to the arrival time difference dt between the two levels of sources or receivers separated by the depth difference Δz, and V is the propagation velocity between the two levels of sources or receivers.

Assuming that there is no absorption between the two levels, which is a reasonable assumption in a consolidated media, and that Δz is in the order of a few meters, the relationship between up-going wave P and the down-going waves G at the two levels can be written as:

G₂(f)=G₁(F)/τ (5)

P₂(f)=τ·P₁(f) (6)

P₁(f)=[S₁(f)−S₂(f)/τ]/[1−(1/τ)²] (7)

G₁(f)=[S₁(f)−τ·S₂(f)]/[1−τ²] (8)

In equation (7) and (8), we have a zero denominator when τ=1, which occurs in several situations including when:

f=n/(2·τ) (9)

The condition defined in equation (9) corresponds to a set of spurious frequencies (i.e., harmonics) that may not be separated by aligning the primary reflections P. However, an appropriate choice of the depth difference Δz places the first spurious frequency (n=1) at the upper edge of a selected useful (processing) bandwidth as demonstrated in the following table 1:

TABLE 1

| | V = 1000 m/s | V = 1500 m/s | V = 2500 m/s |
|---|---|---|---|
| Δz = 3 m | f = 166.67 Hz | f = 250 Hz | f = 416.67 Hz |
| Δz = 6 m | f = 83.33 Hz | f = 125 Hz | f = 208.33 Hz |

One of skill in the art will appreciate the advantages of being able to place the spurious (potentially non-separable) frequency at the upper edge of the processing bandwidth by controlling the depth difference for the plural depth sources or receivers. In addition to the above, a pre-whitening signal w may be used during processing to reduce the effect of the spurious frequencies. For example, a whitening signal w may be leveraged according to the following equations to reduce the effect of the spurious frequencies and improve the quality of the seismic image:

w>|1−(1/τ)²| (10)

P₁(f)=[S₁(f)−S₂(f)/τ]/w (11)

G₁(f)=[S₁(f)−τ·S₂(f)]/w (12)

FIG. 5b is a timing diagram depicting shifted primary and ghost reflections associated with a shifting subsurface in a 4D seismic survey that leverages a plural depth source or a plural depth receiver spread. As is shown, reduced ghost reflections 434 or 534 may enable better detection of subsurface changes by enabling improved detection of a timing shift for the primary reflections 432 or 532 over single depth surveys. The timing shift 560 may be used to determine a corresponding subsurface shift (not shown).

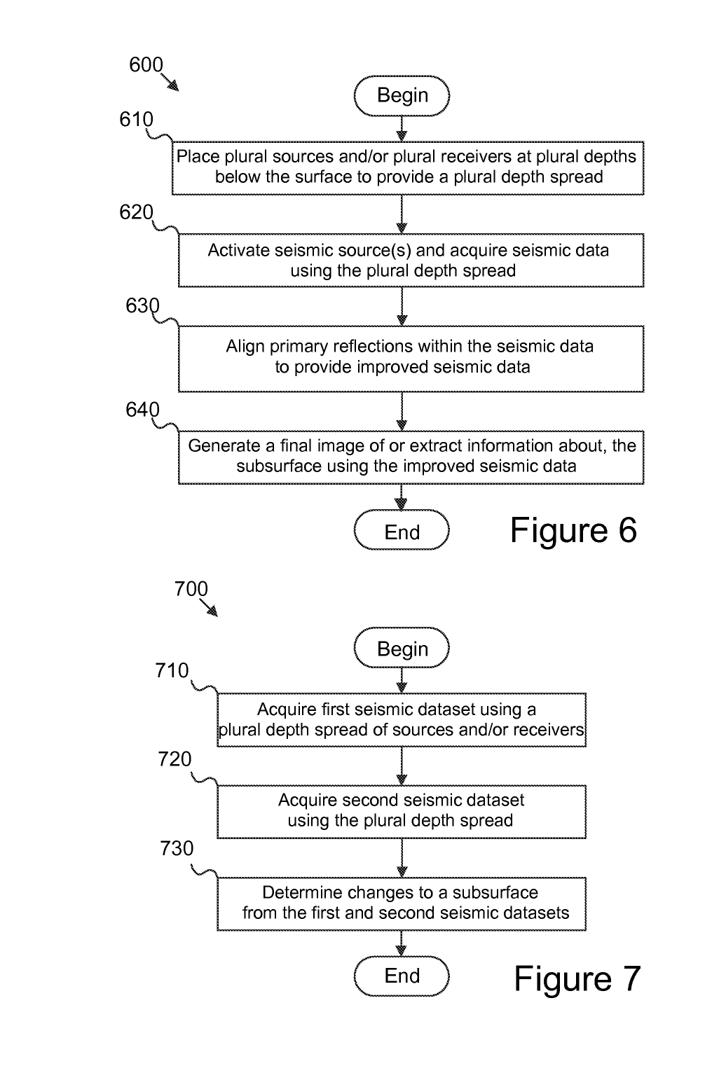

FIG. 6 is a flowchart diagram depicting one embodiment of a plural depth seismic processing method 600. As depicted, the method 600 includes, placing (610) plural sources and/or plural receivers at plural depths to provide a plural depth spread, activating one or more seismic sources and acquiring (620) seismic data using the plural depth spread, aligning (630) primary reflections within the seismic data, and generating a final image of, or extracting information about, the subsurface (640).

Placing (610) plural sources and/or plural receivers at plural depths may include boring holes into the ground (on land or underwater) into which multiple sources and/or receivers are placed. In some embodiments, two or more sources and/or receivers may be placed into the same hole at different depths. The placed sources and receivers may provide a plural depth spread 410 and/or a plural depth spread 510.

Activating one or more seismic sources and acquiring (620) seismic data using the plural depth spread may include leveraging the seismic survey system 10 configured as shown in FIG. 3 or using a similar system and configuration. The sources within the system may be fired in a manner that facilitates separation, i.e., impulsive sources may be separated in time while vibratory sources may be separated in time and/or frequency. Frequency separated vibratory sources may be single frequency sources, multi-frequency sources, or chirped sources.

Aligning (630) primary reflections within the seismic data may include determining a depth or position difference between the plural depth sources and/or receivers and using the depth or position difference to align the primary reflections within the seismic data. The depth or position difference may be determined from GPS data for the sources and receivers or from data collected when the sources or receivers were placed by a field crew.

Generating a final image of, or extracting information about, the subsurface (640) may include conducting operations familiar to those of skill in the art such as a common image point (i.e., midpoint) gather, common receiver gather, common source gather, common offset gather, cross-spread gather, and the like. The final image of the subsurface or the extracted information may communicate specific details about the subsurface including layer boundaries, velocity parameters, saturation, porosity, permeability, amplitude variation with offset or azimuth, or the like.

FIG. 7 is a flowchart diagram depicting one embodiment of a 4D plural depth seismic processing method 700. As depicted, the method 700 includes acquiring (710) a first seismic dataset using a plural depth spread, acquiring (720) a second seismic dataset using the plural depth spread, and determining (730) changes to a subsurface.

The acquiring operations 710 and 720 may be conducted according to the plural depth seismic processing method 600 described above or a similar method. The operation 710 may be conducted on a first seismic dataset collected during a first survey and the operation 720 may be conducted on a second seismic dataset collected during a second survey.

Determining (730) changes to a subsurface from the first and second seismic datasets may include aligning primary reflections within the first and second datasets and conducting various operations including cross-correlation, reservoir inversion, differencing, NRMS, and change prediction.

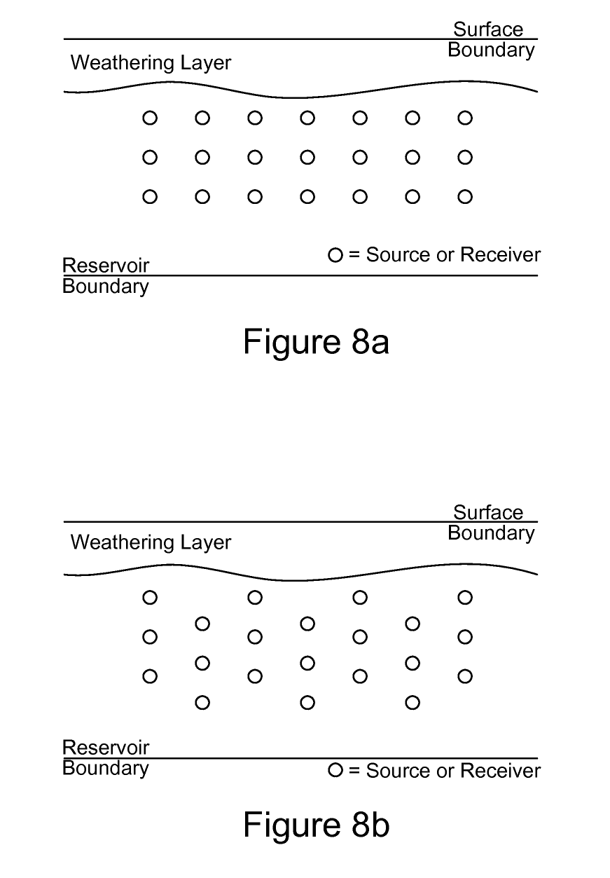

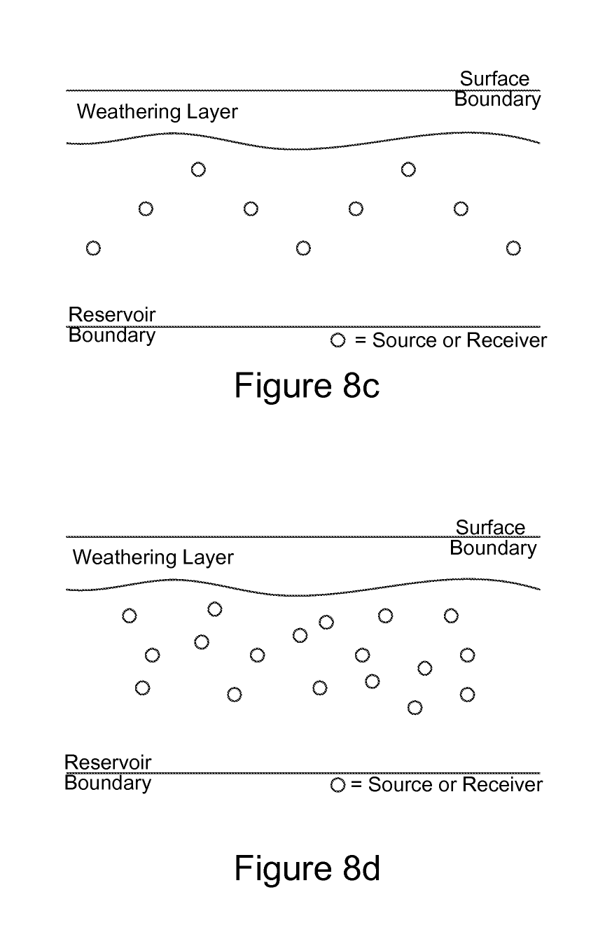

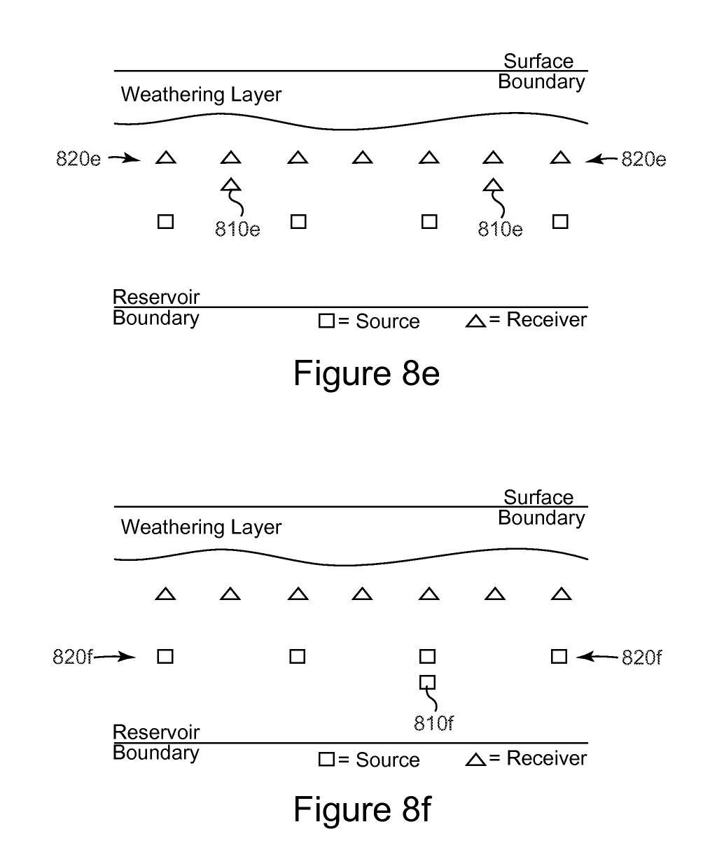

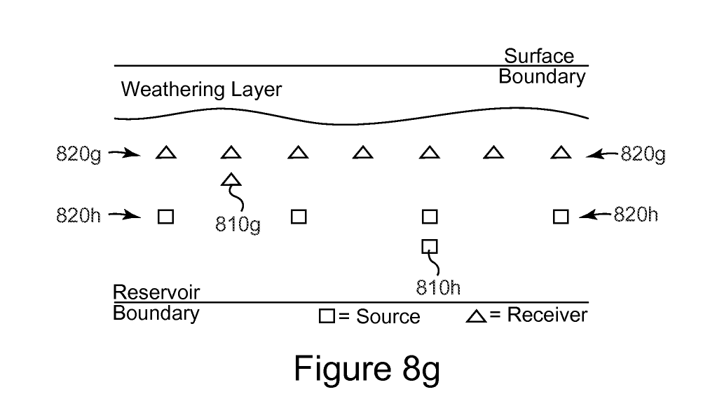

FIGS. 8a-8g are schematic diagrams depicting various placement configurations for plural depth source and/or receiver spreads. The depicted configurations are intended to be illustrative rather than definitive. For example, FIGS. 8a-8g show two-dimensional configurations while actual deployed configurations may be three-dimensional.

FIGS. 8a and 8b depict a grid configuration and an offset grid configuration, respectively. FIG. 8c shows a sawtooth configuration and FIG. 8d shows a random configuration. Selection of a configuration may be application and/or objective dependent. For example, the position of the sources and/or receivers may be selected to minimize aliasing, reduce cost, or a combination thereof.

FIGS. 8e-8g show various examples of plural depth configurations that benefit from having a sparse array 810 that is at a different depth than a primary array 820. A sparse array pertains to an arrangement of plural depths of receivers and/or sources are located below the weathering layer at predefined depth levels. For example, FIG. 8e shows a sparse receiver array 810e at a different depth than the primary receiver array 820e. The sparse receiver 810e is placed at a different depth than the primary array of receivers 820e. The source array is placed at a depth below the sparse array. The number of receivers in the sparse array depends on the area under monitoring. For example, one sparse array may be used for an area of 1 km². However, any number of sparse arrays may be use. Similarly, FIG. 8f shows a sparse source array 810f at a different depth than the primary source array 820f. Here the receivers are placed at a depth less than the primary source array 820f. The sparse source array 810f may be placed at a greater depth than the primary source array 820f. FIG. 8g shows both a sparse receiver array 810g and a sparse source array 810h that are at different depths than a primary receiver array 820g and a primary source array 820h, respectively. By using the methods disclosed herein, or similar methods, each source or receiver within the sparse arrays 810 may be used to de-ghost sources or receivers within the primary arrays 820 that are proximate to the particular source or receiver within the sparse arrays 810. For example, in some embodiments, primary and ghost waves are separated using a sparse array (e.g., the sparse receiver array 810e shown in FIG. 8e) on a repeated basis in order to determine ghost variation. Subsequently, the ghost variation may be leveraged according to the methods described in the commonly assigned U.S. patent application Ser. No. 13/766,213, which is incorporated herein by reference, to deghost other sources or receivers (e.g., the receiver array 820e shown in FIG. 8e).

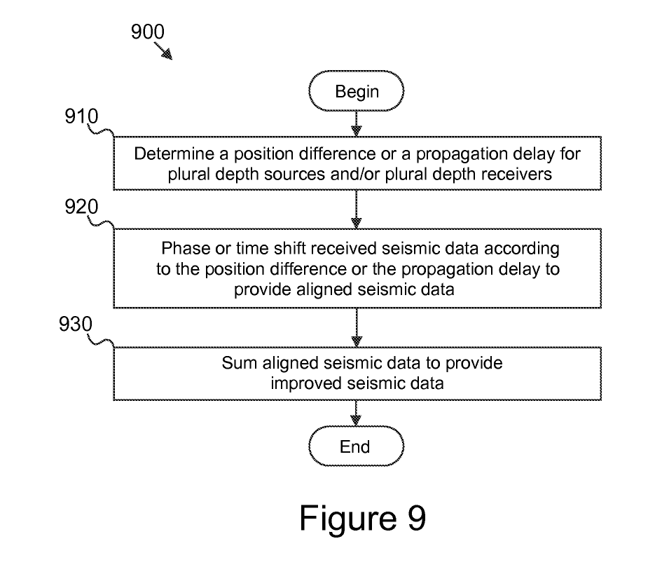

FIG. 9 is a flowchart diagram depicting one embodiment of a plural depth processing method 900. As depicted, the method 900 includes determining 910 a position difference or a propagation delay for plural depth sources and/or plural depth receivers, phase or time shifting 920 received seismic data according to the position difference or propagation delay to provide aligned seismic data, and summing 930 the aligned seismic data to provide improved seismic data. The improved seismic data provided by the method 900 may enable improved subsurface imaging and change detection.

Determining 910 a position difference or a propagation delay for plural depth sources and/or plural depth receivers may include accessing GPS data for the plural depth sources and/or receivers. In some embodiments, the propagation delay is computed directly from synchronized seismic traces. In some situations, the position difference may be substantially identical to a depth difference.

Phase or time shifting 920 received seismic data according to the position difference or propagation delay may include determining an average velocity within the spread and converting the position difference to a phase or time difference. In another embodiment, the phase or time difference is computed directly from the seismic traces. A time difference may be converted to a specific phase by knowing the frequency content of the source. Phase or time shifting the seismic data according to the position difference or the propagation delay may align the primary reflections within the seismic data and thereby provide aligned seismic data.

Summing 930 the aligned seismic data may include summing traces that have their primary reflections aligned with one another. One of skill in the art may recognize that operations 920 and 930 may be accomplished with a digital filter that includes one or more taps corresponding to phase shift terms.

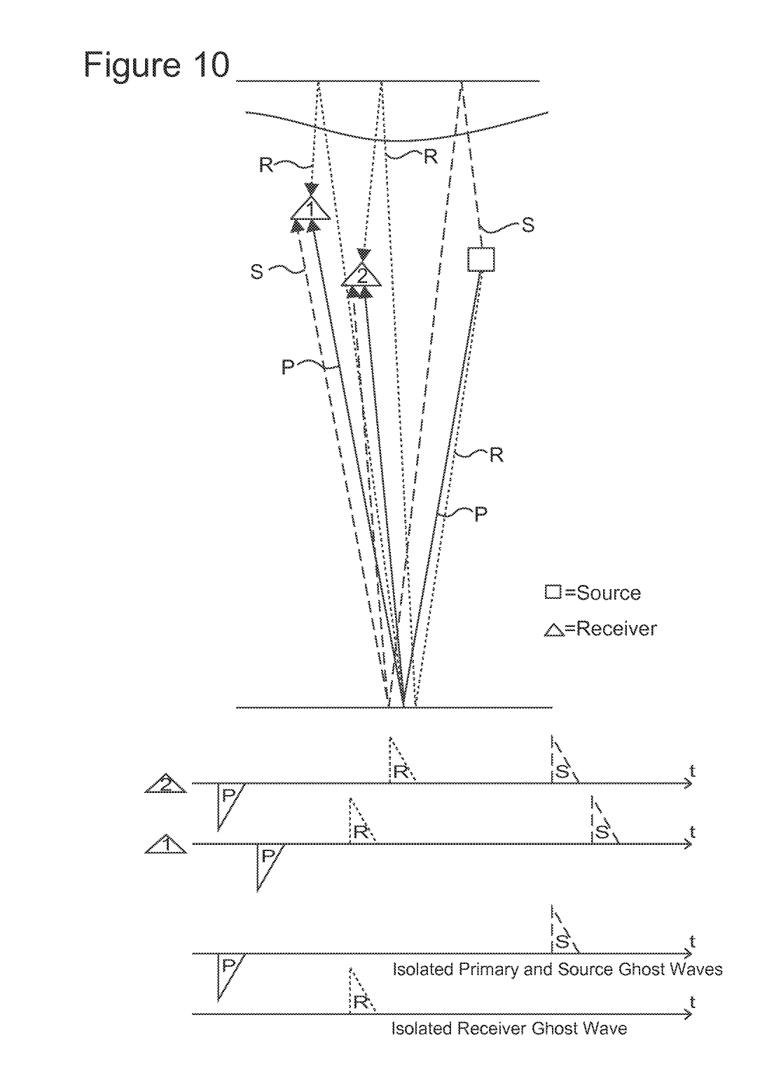

FIG. 10 is a timing and schematic diagram illustrating how a receiver ghost signal can be isolated from a primary signal and a source ghost signal via dual-depth sensors and substantially completely removed from the seismic data. The configuration illustrated in the FIG. 10 represents a representative step of multiple acquisition scenarios explained in FIG. 8. The configuration illustrated in FIG. 10 assumes upgoing and downgoing waves that are essentially vertical and planar. Onshore, such an assumption is acceptable as a velocity gradient is often observed in the shallow subsoil resulting in highly vertical propagation. By reciprocity, a source ghost could be separated at a plural depth source array with one receiver using a similar scheme. We consider first any receiver location on the acquisition spread. The seismic data recorded by a receiver can be expressed as:

Z_{(s,r,f,c)}=P_{(s,r,f,c)}+R_{(s,r,f,c)}+S_{(s,r,f,c)}+N_{(r,f,c)} (13)

where the recorded seismic data Z comprises primary waves P, receiver ghost waves R, source ghost waves S, and noise signal N. In this example, waves P, R, S have four dimensions, namely s corresponding to the considered source, r corresponding to the considered receiver, f corresponding to the selected frequency and c corresponding to the calendar time. Consequently, Z may be referred to as a calendar trace gather, namely the seismic record between one source and one receiver over calendar time. Note that the noise N has only three dimensions as it is independent of the considered active seismic source. Let us consider the waves recorded at the two levels of sensors as shown in FIG. 10. We can write:

Z_{(1,1,f,c)}=P_{(1,1,f,c)}+R_{(1,1,f,c)}+S_{(1,1,f,c)}+N_{(1,f,c)} (14)

Z_{(1,2,f,c)}=P_{(1,2,f,c)}+R_{(1,2,f,c)}+S_{(1,2,f,c)}+N_{(2,f,c)} (15)

Normally it is convenient to assume no absorption between two levels of sources or receivers since the depth difference is of an order of a few meters in a consolidated media. The equations (14) and (15) may be written in simplified notion below as equation (16) and (17) respectively, assuming noise is negligible relative to the primary and ghost signals

Z1=P1+R1+S1 (16)

Z2=P2+R2+S2 (17)

However, if there is any absorption between the two levels of sources, absorption compensation may be applied to the two comparable traces and the equations 16 and 17 may be written with absorption or amplitude compensation as equation 16 (i) and equation 17(i) respectively

aZ1=aP1+aR1+aS1 (16(i))

bZ2=bP2+bR2+bS2 (17(i))

wherein, a and b in equation (16(i)) and (17(i)), respectively are the absorption compensation/amplitude compensation factors.

Now proceeding with the assumption that there is no absorption between the two levels of sources, the relationship between the primary waves and the ghost waves at the two levels can be written (similar to equations (7) and (8)) as:

$$\begin{matrix}P 2 + S 2 = \frac{Z 2 - \frac{Z 1}{τ}}{1 - \frac{1}{{τ}^{2}}} & ( 18 ) \\ R 2 = \frac{Z 2 - τ Z 1}{1 - {τ}^{2}} & ( 19 )\end{matrix}$$

wherein, τ is a phase term that describes arrival time delay between the primary wave and the ghost wave. Value of τ may be determined as:

τ=e^{-2πf(dt)}; dt=Δz/V (20)

wherein, V is the propagation velocity between the two levels of sources or the two levels of receivers separated by a depth distance Δz.

In equation (18) & (19), we can separate the receiver ghost from the primary wave and the source ghost, however we have a zero denominator for certain values of τ:

$$For example , τ = 1 , τ = 0 , f = 0 , f = \frac{K}{2 τ} ; . \qquad ( 21 )$$

These values corresponds to a set of spurious frequencies that may not be separated by aligning the primary reflections P. However, appropriate choice of depth difference places the first spurious frequency (n=1) at the upper edge of a selected useful (processing) bandwidth as shown previously in Table 1.

Further, a pre-whitening signal w may be used to remove the effect of the spurious frequencies wherein

$$\vert 1 - \frac{1}{{τ}^{2}} \vert < w \qquad ( 22 )$$

When the conditions described in the equation (21) are met, the equation (18) and equation (19) can be written as

$$P 2 + S 2 = \frac{Z 2 - \frac{Z 1}{τ}}{w}$$

$$R 2 = \frac{Z 2 - τ Z 1}{w}$$

The receiver ghost (R2) calculated as a part of dual depth sensor array processing may be used to separate either any source ghost for any receiver ghost using high redundancy calendar time for a time lapse or 4D data.

Now if the monitoring in performed using the sparse acquisition or plural depth acquisition as mentioned in the FIG. 8(e)-8(g) additional processing steps are needed to obtain deghosted seismic data. Consider FIG. 10 as an incident in a continuous monitoring scenario. So the seismic trace recorded at one of the receiver can be expressed as described in equation (13)

Z_{(s,r,f,c)}=P_{(s,r,f,c)}+R_{(s,r,f,c)}+S_{(s,r,f,c)}+N_{(r,f,c)} (23)

For a source-receiver couple (i.e. a seismic trace over the calendartime) for a given frequency the equation (23) becomes

Zn(c)=Pn(c)+Rn(c)+Sn(c)+Nn(c) (24)

Now the variation of the calendar trace Zn′ is obtained as below

$${Zn}^{′} ( c ) = Zn ( c ) - ( \frac{1}{c} \sum Zn ( c ) ) = {Pn}^{′} ( c ) + {Sn}^{′} ( c ) + {Rn}^{′} ( c ) + {Nn}^{′} ( c ) \qquad ( 25 )$$

wherein,

$${Pn}^{′} ( c ) = Pn ( c ) - ( \frac{1}{c} \sum Pn ( c ) )$$

$${Sn}^{′} ( c ) = Sn ( c ) - ( \frac{1}{c} \sum Sn ( c ) )$$

$${Rn}^{′} ( c ) = Rn ( c ) - ( \frac{1}{c} \sum Rn ( c ) )$$

$${Nn}^{′} ( c ) = Nn ( c ) - ( \frac{1}{c} \sum Nn ( c ) )$$

Assuming variations in the reservoir during the time lapse survey is minimum thus primary variations induced by reservoir changes may be considered negligible compared to the ghost variations,

$${Pn}^{′} ( c ) = Pn ( c ) - ( \frac{1}{c} \sum Pn ( c ) ) \approx 0$$

Now the equation (25) becomes:

Zn′(c)=Sn′(c)+Rn′(c)+Nn′(c)

Similarly, the variation in the receiver ghost R2′ corresponding to the receiver ghost R2 identified at the plural depth array of sensor may be determined as

$$R {2}^{′} = [ \begin{matrix}R {1}^{′} ( k ) \\ ⋮ \\ R {1}^{′} ( x )\end{matrix} ] ; R 2 = [ \begin{matrix}R 1 ( k ) \\ ⋮ \\ R 1 ( x )\end{matrix} ] ;$$

$${Zn}^{′} = [ \begin{matrix}{Sn}^{′} ( k ) + {Rn}^{′} ( k ) + {Nn}^{′} ( k ) \\ ⋮ \\ {Sn}^{′} ( x ) + {Rn}^{′} ( x ) + {Nn}^{′} ( x )\end{matrix} ]$$

$$Zn = [ \begin{matrix}Pn ( k ) + Sn ( k ) + Rn ( k ) + Nn ( k ) \\ ⋮ \\ Pn ( x ) + Sn ( x ) + Rn ( x ) + Nn ( x )\end{matrix} ]$$

If the variation of the ghost R1′ are comparable to the variations of the plural source and receiver ghosts covered in Zn′, a matching operator α can be derived by resolving a simple least squares problem for a given frequency:

R2′=αZn′ (26)

For a given frequency, the matching operator α can be derived by

$$α = \frac{R 2 {′}^{T} Zn ′}{R 2 {′}^{T} R 2 ′} \qquad ( 27 )$$

The matching operator remains constant over the calendar time for a given frequency. Also, the value of the matching operator can be determined by selecting plural short periods
During the selection of the calculated receiver ghost (R1′) and the variation of the calendartrace (Zn′) may be composed of suitable non-consecutive records; however the resulting metrix should be of same size.
Finally the calendarwave separation that gives a deghosted calendar seismic record can be written as:

Sn′+Rn′=R2′*α;

Sn+Rn=R2*α;

ZnDeg=Zn−R2*α

wherein, ZnDeg is calendar trace after deghosting, Zn is calendar trace before deghosting. Similar process may be used to remove the source ghosts.

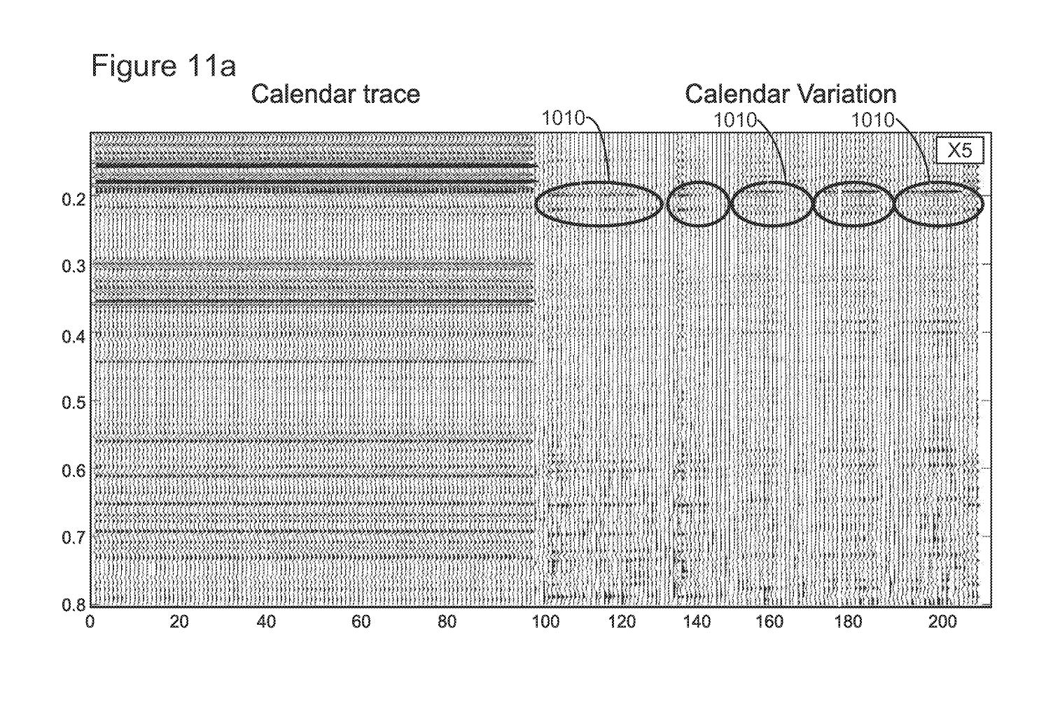

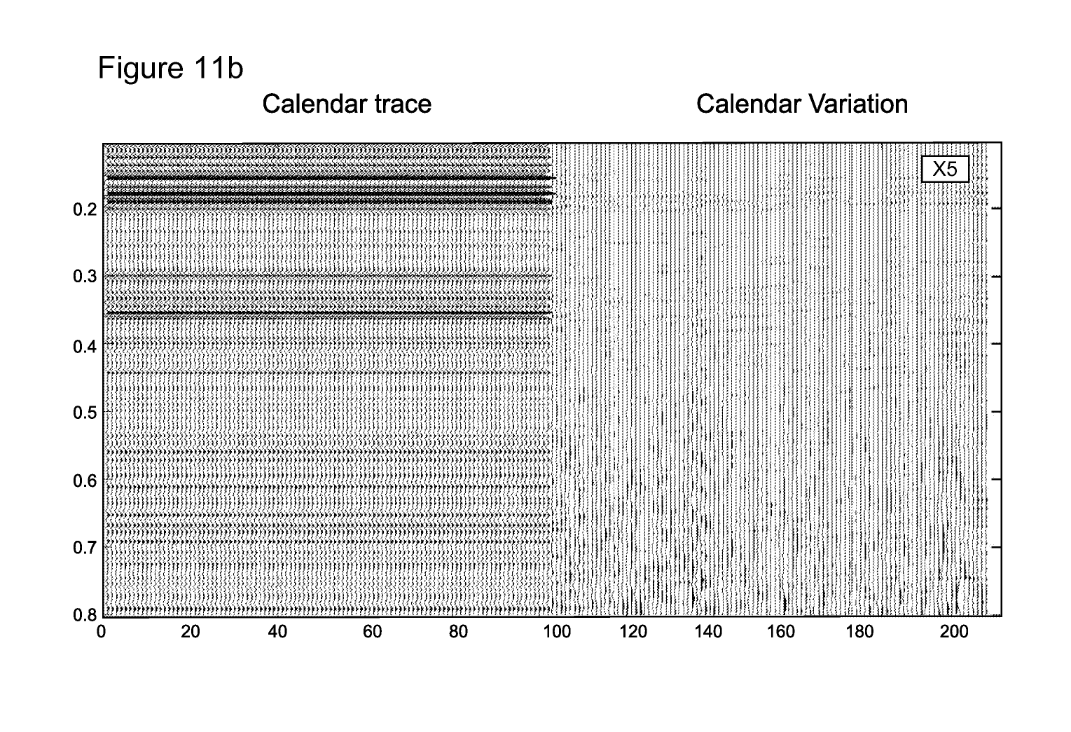

FIGS. 11a and 11b show one specific example of the improvements that may be attained with plural depth sources and receivers over conventional configurations using the methods described herein. FIG. 11a is a plot of seismic data processed from conventional single depth seismic sources and receivers and FIG. 11b is a plot of seismic data processed from plural depth seismic sources at depths of 25, 28, and 35 meters and plural depth receivers at depths of 6 and 9 meters. FIGS. 11a and 11b were generated from real seismic data collected for the same region. FIG. 11a was processed using conventional techniques while FIG. 11b was processed using the methods described herein.

As mentioned above, Applicants have observed that the data precision and stability obtained with the systems and methods disclosed herein enable subsurface change detection with shorter elapsed times and for smaller amplitude variations than previously possible. FIGS. 11a and 11b are evidence of that observed improvement. While FIG. 11a shows significant residual noise 1010 (highlighted with oval annotations), the residual noise is substantially eliminated in FIG. 11b.

In addition to shorter elapsed times and detection of smaller amplitude variations, the systems and methods disclosed herein may increase the signal-to-noise ratio of seismic data, improve 4D seismic repeatability, increase frequency content, reduce positioning error between acquisitions, subdue industrial noise, and enable Stratigraphic Inversion. Applicants assert that improvement in the aforementioned metrics and attributes may be seen with depth variations of less than 0.3 meters (corresponding to a propagation delay of less than 0.25 milliseconds).

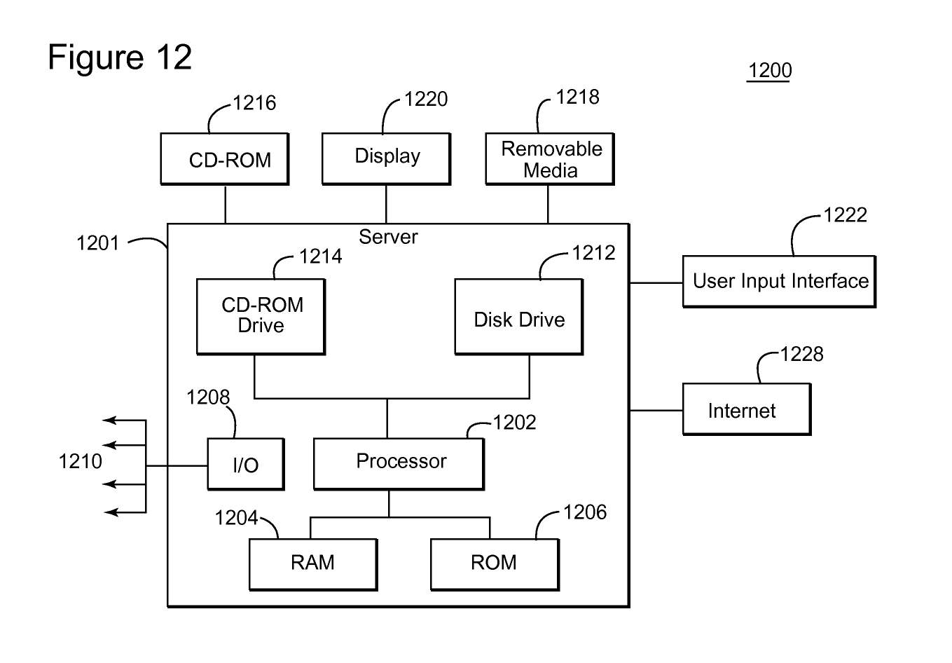

The above-discussed procedures and methods may be implemented partially or wholly in the computing device illustrated in FIG. 12. Hardware, firmware, software, or a combination thereof may be used to perform the various steps and operations described herein. The computing device 1200 of FIG. 12 is an exemplary computing structure that may be used in connection with such a system.

The computing device 1200 may include a server 1201. Such a server 1201 may include a central processor (CPU) 1202 coupled to a random access memory (RAM) 1204 and to a read only memory (ROM) 1206. The ROM 1206 may also be other types of storage media to store programs, such as programmable ROM (PROM), erasable PROM (EPROM), etc. The processor 1202 may communicate with other internal and external components through input/output (I/O) circuitry 1208 and bussing 1210, to provide control signals and the like. The processor 1202 carries out a variety of functions as are known in the art, as dictated by software and/or firmware instructions.

The server 1201 may also include one or more data storage devices, including disk drives 1212, CDDROM drives 1214, and other hardware capable of reading and/or storing information such as DVD, etc. In one embodiment, software for carrying out the above-discussed steps may be stored and distributed on a CDDROM or DVD 1216, a USB storage device 1218 or other form of media capable of portably storing information. These storage media may be inserted into, and read by, devices such as the CDDROM drive 1214, the disk drive 1212, etc. The server 1201 may be coupled to a display 1220, which may be any type of known display or presentation screen, such as LCD displays, plasma display, cathode ray tubes (CRT), etc. A user input interface 1222 is provided, including one or more user interface mechanisms such as a mouse, keyboard, microphone, touchpad, touch screen, voice-recognition system, etc.

The server 1201 may be coupled to other devices, such as sources, detectors, etc. The server may be part of a larger network configuration as in a global area network (GAN) such as the Internet 1228, which allows ultimate connection to the various landline and/or mobile computing devices.

The disclosed exemplary embodiments provide a computing device, a method for acquiring and de-ghosting seismic data, and systems corresponding thereto. For example, the disclosed computing device and method could be integrated into a variety of seismic survey and processing systems including land, ocean bottom, and transitional zone systems with either cabled or autonomous data acquisition nodes. It should be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations and sequences with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for de-ghosting seismic data, the method comprising:
receiving seismic data corresponding to plural depth sources or plural depth receivers located at a first depth and a second depth below a geophysical surface, wherein the second depth is below the first depth;
the plural depth sources or plural depth receivers comprising a first seismic receiver located at the first depth and a second seismic receiver located at the second depth, or, a first seismic source located at the first depth and a second seismic source located at the second depth; and
aligning primary reflections within the seismic data to provide improved seismic data.

2. The method of claim 1, wherein aligning the primary reflections misaligns ghost reflections within the seismic data that correspond to regions above the first depth.

3. The method of claim 1, wherein the primary reflections correspond to regions below the second depth.

4. The method of claim 3, further comprising determining changes to the regions below the second depth.

5. The method of claim 4, wherein determining changes to the regions below the second depth comprises comparing the improved seismic data corresponding to a first acquisition event with the improved seismic data corresponding to a second acquisition event.

6. The method of claim 1, further comprising phase-shifting or time-shifting a portion of the seismic data.

7. The method of claim 6, wherein an amount of phase-shifting or time-shifting corresponds to a propagation delay between the first seismic source and the second seismic source or the first seismic receiver and the second seismic receiver.

8. The method of claim 1, further comprising acquiring seismic data with another seismic receiver.

9. A system for de-ghosting seismic data, the system comprising:
plural depth sources or plural depth receivers comprising a first seismic receiver located at a first depth and a second seismic receiver located at a second depth, or, a first seismic source located at the first depth and a second seismic source located at the second depth;
wherein the second depth is below the first depth; and
a processor configured to aligning primary reflections within the seismic data to provide improved seismic data.

10. The system of claim 9, wherein aligning the primary reflections misaligns ghost reflections within the seismic data that correspond to regions above the first depth.

11. The system of claim 9, wherein the primary reflections correspond to regions below the second depth.

12. The system of claim 11, wherein the processor is configured to determine changes to the regions below the second depth.

13. The system of claim 11, wherein the processor determines the changes to the regions below the second depth by comparing the improved seismic data corresponding to a first acquisition event with the improved seismic data corresponding to a second acquisition event.

14. The system of claim 9, wherein the processor is configured to phase-shift or time-shift a portion of the seismic data.

15. The system of claim 14, wherein an amount of phase-shift or time-shift corresponds to a propagation delay between the first seismic source and the second seismic source or the first seismic receiver and the second seismic receiver.

16. A method for de-ghosting seismic data, the method comprising:
receiving seismic data corresponding to plural depth sources or plural depth receivers located at a first depth and a second depth below a geophysical surface, wherein the second depth is below the first depth;
the plural depth sources or plural depth receivers comprising a first seismic receiver located at the first depth and a second seismic receiver located at the second depth, or, a first seismic source located at the first depth and a second seismic source located at the second depth;
determining a position difference or a propagation delay corresponding to the plural depth sources or the plural depth receivers; and
providing improved seismic data from the seismic data by using the position difference or the propagation delay to align primary reflections within the seismic data.

17. The method of claim 16, wherein aligning the primary reflections misaligns ghost reflections within the seismic data that correspond to regions above the first depth.

18. The method of claim 16, wherein the primary reflections correspond to regions below the second depth.

19. The method of claim 18, further comprising determining changes to the regions below the second depth.

20. The method of claim 19, wherein determining changes to the regions below the second depth comprises comparing the improved seismic data corresponding to a first acquisition event with improved seismic data corresponding to a second acquisition event.
